(19) United States
(12) Patent Application Publication
(10) Pub. No.: US 2010/0061656 A1
(43) Pub. Date: Mar. 11, 2010

(54) NOISE REDUCTION OF AN IMAGE SIGNAL

(75) Inventor: Rafael Wiemker, Kisdorf (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/513,507

(22) PCT Filed: Nov. 1, 2007
(86) PCT No.: PCT/IB07/54434

§ 371 Date: May 5, 2009

(30) Foreign Application Priority Data
Nov. 8, 2006 (EP) 06123697.2

(51) Int. Cl. G06K 9/40

(52) U.S. Cl. 382/275

(57) ABSTRACT

A process for reducing noise in medical image data is disclosed. Medical image data is received and is converted into a binary image (S30). The Euler histogram, consisting of the Euler number of the binary image data corresponding to several thresholds used to determine the binary image is then determined (S40). The Euler histogram of the binary image data is then compared with that of reference image data (S60) and is used to provide a control signal (S70) to a noise suppression process (S80) for reducing noise in the image data.

### FIELD OF THE INVENTION

The present invention relates to noise reduction of an image signal, and relates particularly, but not exclusively, to noise reduction of medical image data.

### BACKGROUND OF THE INVENTION

In order to reduce x-ray exposure of patients during medical imaging, increasing use is made of ultra-low-dose CT (computer tomography) imaging. However, images obtained by means of this method contain large amounts of noise, and it is therefore necessary to carry out image restoration before computer aided quantification of clinical parameters can take place. Also, many computer-aided measurements of clinical parameters cannot be directly compared between medical images having different noise levels, and the noise containing images need to be subjected to noise suppression filters before a comparison can take place. However, a wide variety of noise suppression filters for image restoration is known, such as Gaussian smoothing, binomial smoothing, median filtering, mean-shift filtering, un-isotropic diffusion, and un-isotropic smoothing with steerable filters. Each of these types of noise suppression filter requires one or more parameters to control the strength of the effect of the filter. However, the degree of strength of application of noise suppression filter is usually unknown, and may need to be set individually for each new image. This can have a significant effect on the estimation of clinical parameters from the image.

Marc Hensel et al., “Motion and Noise Detection for Adaptive Spatio-Temporal Filtering of Medical X-Ray Image Sequences”, 9th Annual Conference on Medical Image Understanding and Analysis 2005 (MIUA 2005), pp. 219-222, Bristol, U.K., Jul. 19-20, 2005 describe the use of the Euler number of different thresholds for the detection of motion in a time series of medical X-ray images. Difference images between subsequent X-ray images are considered. For each voxel which differs between one image and the following one, a decision is sought whether a difference in brightness stems from noise or from motion. In order to achieve this, the Euler number is computed for various thresholds of the difference images of the time series, and then a certain point in the resulting Euler curve is determined. However, the Euler curve of the difference image is determined in a very time-consuming manner, by generating first a binary image from the difference image for every possible threshold, and then computing the Euler number for each binary image.

### SUMMARY OF THE INVENTION

It is an object of the present invention to enable the strength of application of noise suppression filters to be automatically controlled, and to enable the most appropriate image restoration method to be selected to provide a result most similar to a desired non-noisy target image.

According to an aspect of the present invention, there is provided a method of processing image data, the method comprising:

receiving first input image data representing at least one image of an object and including a plurality of first data sets, wherein each said first data set includes a respective first component representing a detected physical parameter at a respective location of the object;

providing binary image data representing a respective binary image corresponding to at least one said image and including a respective plurality of second data sets corresponding to each said first data set, wherein each said second data set includes a respective second component having a first or second value determined by means of a comparison of the first component of the corresponding said first data set with a respective threshold value;

determining a respective Euler number of a respective plurality of said binary images corresponding to at least one said image;

providing at least one control signal dependent upon said plurality of Euler numbers;

applying a noise suppression process to said input image data to provide output image data; and

controlling said noise suppression process by means of at least one said control signal.

By controlling a noise suppression process by means of at least one control signal dependent upon the respective Euler numbers of a plurality of binary images corresponding to different threshold values, this provides the advantage of enabling automatic control of the strength of application of an image restoration filter. Also, because the control signal provided by the method of the invention contains information relating to the noise content of an image, the invention also provides the advantage of enabling images provided by means of different imaging processes (and therefore having differing noise content) to be compared with each other, and also enables the most appropriate image restoration method to be selected to provide a result most similar to a desired non-noisy target image.

In one preferred embodiment, the step of determining a respective Euler number of a respective plurality of said binary images comprises determining whether each of a plurality of said second data sets represents a respective vertex, edge or face of the corresponding said binary image.

By determining whether each of a plurality of said second data sets represents a respective vertex, edge or face of the corresponding said binary image, this provides the advantage of enabling the Euler number of a respective binary image to be determined by means of summation of the Euler numbers of component parts of the binary image.

The step of determining whether each of a plurality of said second data sets represents a respective vertex, edge or face may comprise (a) determining whether a predetermined second data set corresponding to a predetermined position of said object represents a vertex, edge or face of a binary image corresponding to a first threshold value, and (b) classifying further second data sets corresponding to said predetermined position and corresponding to second threshold values, lower than said first threshold value, according to the determination carried out at step (a).

By determining whether a predetermined second data set corresponding to a predetermined position of said object represents a vertex, edge or face of a binary image corresponding to a first threshold value, and classifying further second data sets corresponding to lower threshold values according to that determination, this provides the advantage of enabling the Euler numbers to be determined in an efficient manner. For example, whether a predetermined second data set corresponds to a vertex, edge or face can be determined for the highest threshold value used, and those second data sets corresponding to a vertex, edge or face will also correspond to a respective vertex, edge or face for all lower threshold values. This provides the surprising advantage that the software effort required has a linear relationship to the number of pixels or voxels in the image, whereas it had been believed in the relevant art that the software effort required was a function of the product of the number of pixels or voxels in the image and the number of thresholds used. This in turn enables the determination for each pixel of voxel of an image to be carried out in a single raster scan, which is very software efficient. This therefore allows rapid computation of the output image data and only requires simple and compact software code.

The step of determining whether a predetermined said second data set represents a vertex may comprise determining when said second component of said predetermined second data set becomes greater than a said second threshold value.

The step of determining whether a predetermined said second data set represents an edge may comprise determining when the lower of said second component of (i) said predetermined second data set and (ii) a second data set corresponding to a position adjacent to that of said predetermined second data set becomes greater than a said second threshold value.

The step of determining whether a predetermined said second data set represents a face may comprise determining when the lowest of said second component of (i) said predetermined second data set and (ii) a plurality of second data sets corresponding to respective positions adjacent to that of said predetermined second data set becomes greater than a said second threshold value.

The step of determining a respective Euler number of a respective plurality of said binary images may further comprise determining whether each of a plurality of said second data sets represents a respective octant of the corresponding said binary image.

This provides the advantage of enabling the method to be applied to 3D image data.

The step of providing at least one control signal dependent upon said plurality of Euler numbers may comprise determining a correlation between (i) said plurality of Euler numbers corresponding to a said image and (ii) a plurality of Euler numbers corresponding to a target image.

The step of providing at least one control signal dependent upon said plurality of Euler numbers may comprise determining a correlation between (i) said plurality of Euler numbers corresponding to a said image and (ii) a plurality of Euler numbers corresponding to an image represented by second input image data.

According to another aspect of the present invention, there is provided an image processing apparatus for processing image data, the apparatus comprising at least one processor for:

receiving first input image data representing at least one image of an object and including a plurality of first data sets, wherein each said first data set includes a respective first component representing a detected physical parameter at a respective location of the object;

providing binary image data representing a respective binary image corresponding to at least one said image and including a respective plurality of second data sets corresponding to each said first data set, wherein each said second data set includes a respective second component having a first or second value determined by means of a comparison of the first component of the corresponding said first data set with a respective threshold value;

determining a respective Euler number of a respective plurality of said binary images corresponding to at least one said image;

providing at least one control signal dependent upon said plurality of Euler numbers;

applying a noise suppression process to said input image data to provide output image data; and

controlling said noise suppression process by means of at least one said control signal.

According to a further aspect of the present invention, there is provided an imaging apparatus comprising an image forming device for providing first input image data representing at least one image of an object and including a plurality of first data sets, wherein each said first data set includes a respective first component representing a detected physical parameter at a respective location of the object, and an image processing apparatus as defined above.

According to a further aspect of the present invention, there is provided a data structure for use by a computer for processing image data, the data structure comprising:

first computer code executable to receive first input image data representing at least one image of an object and including a plurality of first data sets, wherein each said first data set includes a respective first component representing a detected physical parameter at a respective location of the object;

second computer code executable to provide binary image data representing a respective binary image corresponding to at least one said image and including a respective plurality of second data sets corresponding to each said first data set, wherein each said second data set includes a respective second component having a first or second value determined by means of a comparison of the first component of the corresponding said first data set with a respective threshold value;

third computer code executable to determine a respective Euler number of a respective plurality of said binary images corresponding to at least one said image;

fourth computer code executable to provide at least one control signal dependent upon said plurality of Euler numbers;

fifth computer code executable to apply a noise suppression process to said input image data to provide output image data; and

sixth computer code executable to control said noise suppression process by means of at least one said control signal.

According to a further aspect of the present invention, there is provided a data structure as defined above and stored on a carrier.

### BRIEF DESCRIPTION OF THE DRAWINGS

A preferred embodiment of the invention will now be described, by way of example only and not in any limitative sense, with reference to the accompanying drawings, in which:

FIG. 1 is a medical imaging apparatus embodying the present invention;

FIG. 2 shows a comparison of a CT standard-dose and ultra-low-dose CT pulmonary scan of a patient's lungs;

FIG. 3 shows a flowchart of a first process for controlling a noise suppression algorithm in a processor of the apparatus of FIG. 1;

FIG. 4 shows a flowchart of a second process for controlling a noise suppression algorithm in a processor of the apparatus of FIG. 1;

FIG. 5 shows a comparison of the standard-dose image with the ultra-low-dose image after no noise reduction filtering, light noise reduction filtering and strong noise reduction filtering, respectively; and

FIG. 6 shows a comparison of normal histograms and Euler histograms between the standard-dose image and low-dose image with the different degrees of noise suppression of FIG. 5.

### DETAILED DESCRIPTION OF EMBODIMENTS

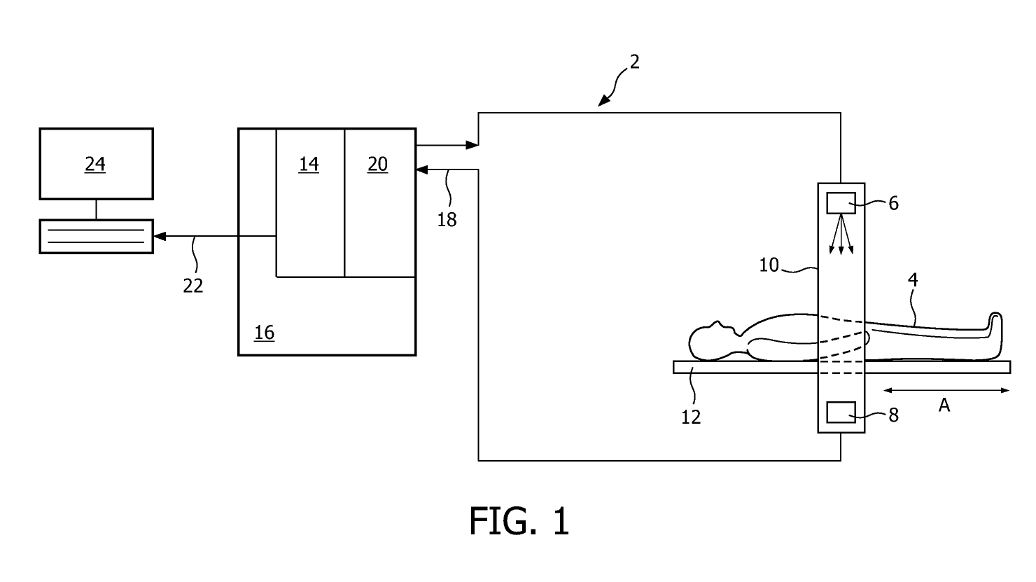

Referring to FIG. 1, a computer tomography (CT) imaging apparatus 2 for providing a pulmonary image of a patient 4 has a plurality of x-ray sources 6 and detectors 8 arranged in opposed pairs around a circular frame 10. The patient 4 is supported on a platform 12 which can be moved in the direction of arrow A relative to the frame 10 by means of a control unit 14 in a computer 16.

The x-ray sources 6 and detectors 8, as well as the movement of the platform 12 are controlled by means of the control unit 14, and data detected by the detectors 8 is input along input lines 18 to a processor 20 of the computer 16. The processor 20 processes the data received along input line 18 to provide a 3-D model of the patient's lungs, and image data is output along output line 22 to a display unit 24 to enable an image of the patient's lungs to be displayed.

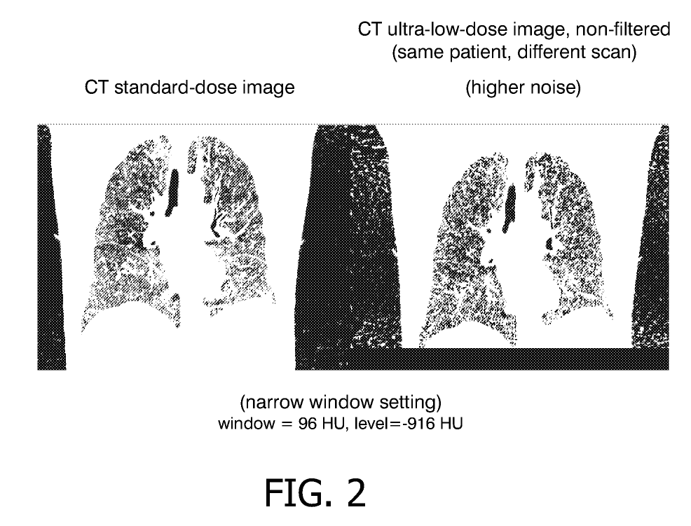

Referring now to FIG. 2, the apparatus can be used to generate a standard-dose image and an ultra-low-dose image of the patient's lungs. FIG. 2 shows a CT standard-dose and ultra-low-dose CT scan of the same patient, with a coronal reformat at approximately the same position, showing much a higher noise level in the ultra-low-dose image.

The image data corresponding to the ultra-low-dose CT scan shown in FIG. 2 is processed in order to obtain binary image data by comparing the grey value of the image intensity with a series of threshold grey values. The binary image data is then obtained for a wide range of threshold values so that a series of binary images can be computed from a single grey value image. The binary image data is then processed to obtain the Euler histogram of the binary image, i.e. the graph of Euler number of the binary image over a selected range of threshold values.

In order to compute the Euler histogram, the Euler number E for a binary image is defined for a 2 dimensional binary image corresponding to those shown in FIG. 2 as:

2E=#vertices−#edges+#faces,

where the vertices and connecting edges and faces can be drawn arbitrarily on the foreground parts of the binary image. For convenience, the vertices are taken as being coincident with the positions on the voxel grid of the image, and the global Euler number can then be computed by summation of local Euler numbers of the component parts.

The processor computes the contribution of each voxel of the binary image to the total number of vertices, edges and faces by starting with a threshold having a high value Tₘₐₓ which is gradually lowered towards a minimum value Tₘᵢₙ. The resulting series of binary images has value 1 at voxels having intensity values greater than or equal to the threshold value T and zero at intensity values less than T.

In order to determine the contribution of vertices for each voxel to the overall Euler histogram, during the process of gradually lowering the threshold T a voxel at position (x,y) with intensity v becomes a vertex in the binary image for the first time when Tᵥₑᵣₜₑₓ=v(x,y) and remains a vertex for all lower threshold values.

Similarly, a voxel becomes part of an edge for the first time when

T_{edge1}=min{v(x,y),v(x+1,y)},

or T_{edge2}=min{v(x,y),v(x,y+1)},

and remains an edge for all lower threshold values.

Similarly, the voxel becomes part of a face for the first time when

T_{face}=min{v(x,y),v(x+1,y),v(x,y+1),v(x+1,y+1)}=min{T_{edge1},T_{edge2},v(x+1,y+1)},

and remains a face for all lower threshold values.

The processor therefore carries out the above computation for each voxel, and then carries out a raster scan of the voxels and repeats the process. In this way, all possible vertices, edges and faces on the voxel grid are covered for all selected threshold values, and the Euler histogram is computed by summing the individual contributions of the separate voxels. This enables the contribution of each voxel to the Euler-histogram for all threshold values to be computed in a single scan, and is therefore very software efficient.

The above process can also be extended to 3D image data where the Euler number E is given by

2E=#vertices−#edges+#faces−#octants

as will be readily understood by persons skilled in the art.

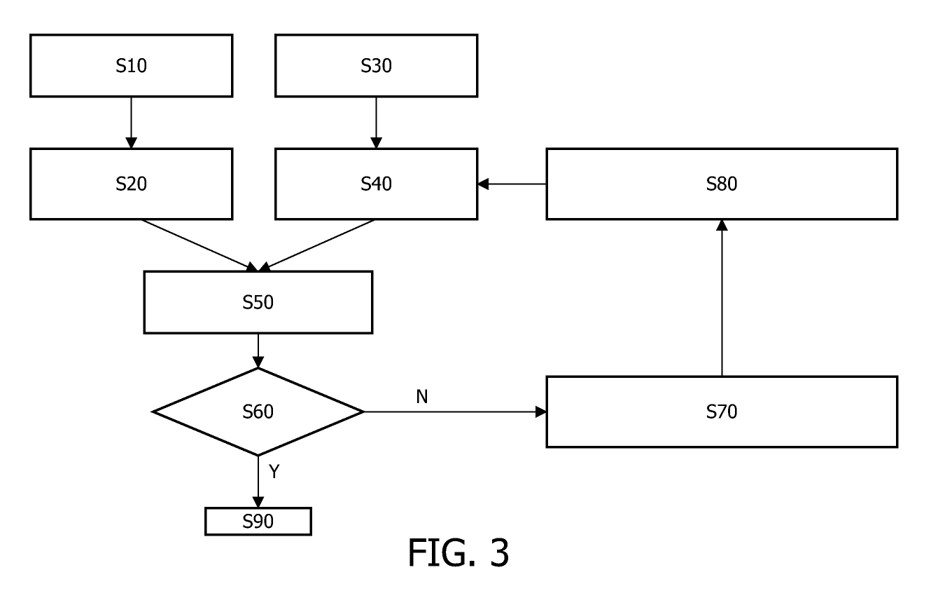

Referring to FIG. 3, a flowchart for a process for controlling a noise suppression algorithm in the processor 20 of the apparatus of FIG. 1 is shown. At step S10, a gray-value reference image, which may be a gray-value image obtained according to a different method from that used to obtain the noisy image to which the noise suppression algorithm is applied, is obtained. The Euler histogram of the gray-value reference image is then obtained at step S20 according to the method described above.

At the same time, the gray-value image, representing the noisy image to be processed compared with a predetermined threshold value, is obtained at step S30. The Euler histogram of the gray-value image is obtained at step S40. At step S50, the degree of similarity between the Euler histograms obtained at steps S20 and S40 is determined, for example by means of a suitable correlation function which will be familiar to persons skilled in the art. If it is then determined at step S60 that the degree of similarity between the Euler histograms differs from the optimal value possible under the circumstances, for example the optimal correlation value of all of the noise suppression algorithms available, the noise suppression algorithm is adjusted at step S70, for example by changing the noise suppression algorithm used, or adjusting its parameters. The adjusted noise suppression algorithm is then applied to the noisy gray-value image at step S80 and the process is repeated until the optimal degree of similarity between the Euler histograms is determined at step S60 and the process then ends at step S90.

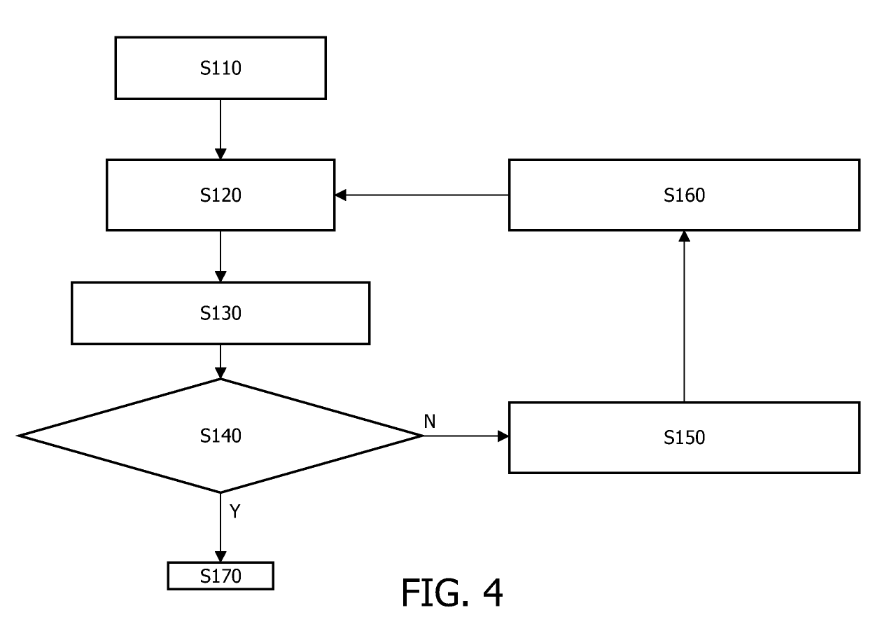

A flowchart for a further process for controlling a noise suppression algorithm in the processor 20 of the apparatus of FIG. 1 is shown in FIG. 4. At step S110, a gray-value image corresponding to the noisy image to be processed is obtained. The Euler histogram of the gray-value image is then obtained at step S120 according to the method described above.

A measure of the noise present in the gray-value image is computed at step S130, and this is compared at step S140 with a predetermined threshold value. If it is determined at step S140 that the noise value does not lie within acceptable limits, the noise suppression algorithm is adjusted at step S150, for example by changing the noise suppression algorithm used, or adjusting its parameters. The adjusted noise suppression algorithm is then applied to the noisy gray-value image at step S160 and the process is repeated until the noise measure is considered at step S140 to lie within acceptable limits, and the process then ends at step S170.

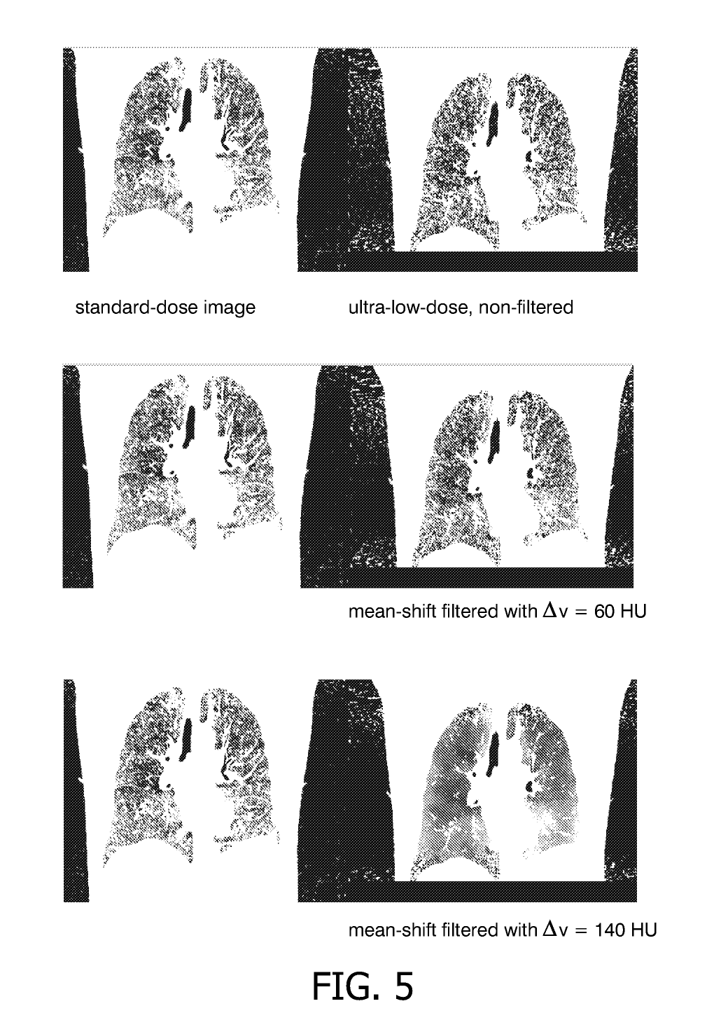

FIG. 5 shows the results of the above process, in which the left hand column shows the standard-dose image, and the right hand column shows the ultra-low-dose image subjected to no noise filtering, light noise filtering, and strong noise filtering respectively. It can be seen that the best quality ultra-low-dose image is that corresponding to light noise filtering.

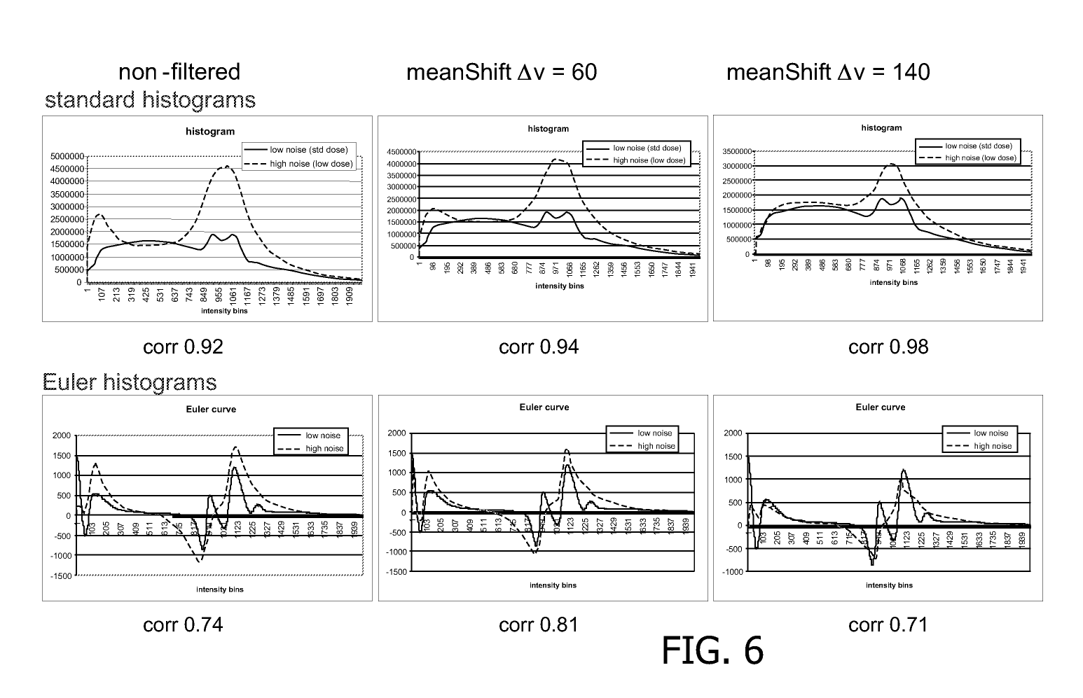

FIG. 6 shows a comparison between the normal histograms (top row) of the standard-dose image and the low-dose image with different degrees of noise-suppression (mean-shift filtering). The bottom row of FIG. 4 shows a comparison of the Euler histograms. As will be appreciated by persons skilled in the art, the units on the x-axis are the so-called bins of the histogram, in this case the gray-values of the image 0 . . . 2000. For CT images, the gray-value usually corresponds to the Hounsfield-value (HU), in this case with an offset of 1000, so that the gray-value 0 means −1000 HU. The y-axis is then the Euler number for the threshold at this gray-value (for the whole volume image, consisting of ca 100 slice-images).

For the normal histogram, the correlation increases with ever-stronger noise-suppression. However, the visual impression is that the similarity is optimal at a filtering strength of Δv=60 HU, which is also the point of optimal correlation of the Euler histograms.

It will be appreciated by person skilled in the art that the above embodiment has been described by way of example only, and not in any limitative sense, and that various alterations and modifications are possible without departure from the scope of the invention as defined by the appended claims. For example, although the invention has been described in relation to medical image processing, it will be appreciated by persons skilled in the art that the invention can be applied to any type of imaging, including photographic and video images.

1. A method of processing image data, the method comprising:
receiving first input image data representing at least one image of an object and including a plurality of first data sets, wherein each said first data set includes a respective first component representing a detected physical parameter at a respective location of the object;
providing binary image data representing a respective binary image corresponding to at least one said image and including a respective plurality of second data sets corresponding to each said first data set, wherein each said second data set includes a respective second component having a first or second value determined by means of a comparison of the first component of the corresponding said first data set with a respective threshold value;
determining a respective Euler number of a respective plurality of said binary images corresponding to at least one said image;
providing at least one control signal dependent upon said plurality of Euler numbers;
applying a noise suppression process to said input image data to provide output image data; and
controlling said noise suppression process by means of at least one said control signal.

2. A method according to claim 1, wherein the step of determining a respective Euler number of a respective plurality of said binary images comprises determining whether each of a plurality of said second data sets represents a respective vertex, edge or face of the corresponding said binary image.

3. A method according to claim 2, wherein the step of determining whether each of a plurality of said second data sets represents a respective vertex, edge or face comprises (a) determining whether a predetermined second data set corresponding to a predetermined position of said object represents a vertex, edge or face of a binary image corresponding to a first threshold value, and (b) classifying further second data sets corresponding to said predetermined position and corresponding to second threshold values, lower than said first threshold value, according to the determination carried out at step (a).

4. A method according to claim 2, wherein the step of determining whether a predetermined said second data set represents a vertex comprises determining when said second component of said predetermined second data set becomes greater than a said second threshold value.

5. A method according to claim 2, wherein the step of determining whether a predetermined said second data set represents an edge comprises determining when the lower of said second component of (i) said predetermined second data set and (ii) a second data set corresponding to a position adjacent to that of said predetermined second data set becomes greater than a said second threshold value.

6. A method according to claim 2, wherein the step of determining whether a predetermined said second data set represents a face comprises determining when the lowest of said second component of (i) said predetermined second data set and (ii) a plurality of second data sets corresponding to respective positions adjacent to that of said predetermined second data set becomes greater than a said second threshold value.

7. A method according to claim 2, wherein the step of determining a respective Euler number of a respective plurality of said binary images further comprises determining whether each of a plurality of said second data sets represents a respective octant of the corresponding said binary image.

8. A method according to claim 1, wherein the step of providing at least one control signal dependent upon said plurality of Euler numbers comprises determining a correlation between (i) said plurality of Euler numbers corresponding to a said image and (ii) a plurality of Euler numbers corresponding to a target image.

9. A method according to claim 1, wherein the step of providing at least one control signal dependent upon said plurality of Euler numbers comprises determining a correlation between (i) said plurality of Euler numbers corresponding to a said image and (ii) a plurality of Euler numbers corresponding to an image represented by second input image data.

10. An image processing apparatus for processing image data, the apparatus comprising at least one processor for:
receiving first input image data representing at least one image of an object and including a plurality of first data sets, wherein each said first data set includes a respective first component representing a detected physical parameter at a respective location of the object;
providing binary image data representing a respective binary image corresponding to at least one said image and including a respective plurality of second data sets corresponding to each said first data set, wherein each said second data set includes a respective second component having a first or second value determined by means of a comparison of the first component of the corresponding said first data set with a respective threshold value;
determining a respective Euler number of a respective plurality of said binary images corresponding to at least one said image;
providing at least one control signal dependent upon said plurality of Euler numbers;
applying a noise suppression process to said input image data to provide output image data; and
controlling said noise suppression process by means of at least one said control signal.

11. An imaging apparatus comprising an image forming device for providing first input image data representing at least one image of an object and including a plurality of first data sets, wherein each said first data set includes a respective first component representing a detected physical parameter at a respective location of the object, and an image processing apparatus according to claim 10.

12. A data structure for use by a computer for processing image data, the data structure comprising:
first computer code executable to receive first input image data representing at least one image of an object and including a plurality of first data sets, wherein each said first data set includes a respective first component representing a detected physical parameter at a respective location of the object;
second computer code executable to provide binary image data representing a respective binary image corresponding to at least one said image and including a respective plurality of second data sets corresponding to each said first data set, wherein each said second data set includes a respective second component having a first or second value determined by means of a comparison of the first component of the corresponding said first data set with a respective threshold value;
third computer code executable to determine a respective Euler number of a respective plurality of said binary images corresponding to at least one said image;
fourth computer code executable to provide at least one control signal dependent upon said plurality of Euler numbers;
fifth computer code executable to apply a noise suppression process to said input image data to provide output image data; and
sixth computer code executable to control said noise suppression process by means of at least one said control signal.

13. A data structure according to claim 12 and stored on a carrier.
